(19) United States
(12) Patent Application Publication
(10) Pub. No.: US 2020/0106223 A1
(43) Pub. Date: Apr. 2, 2020

(54) REMOTE SENSING UNIT

(71) Applicants: Stephen R. Tarte, Tampa, FL (US); Michael E. Stalzer, Tampa, FL (US)

(72) Inventors: Stephen R. Tarte, Tampa, FL (US); Michael E. Stalzer, Tampa, FL (US)

(21) Appl. No.: 16/699,510

(22) Filed: Nov. 29, 2019

Related U.S. Application Data
(63) Continuation of application No. 16/182,145, filed on Nov. 6, 2018.
(60) Provisional application No. 62/648,977, filed on Mar. 28, 2018.
(60) Provisional application No. 62/673,224, filed on May 18, 2018.

(51) Int. Cl. H01R 13/713; H01R 24/28; H01R 13/453; H01R 13/66; H01R 13/717; H01H 47/00; H01R 24/30; H01R 31/06

(52) U.S. Cl. CPC H01R 13/713; H01R 24/28; H01R 13/4538; H01R 13/665; H01R 2103/00; H01H 47/002; H01R 13/7135; H01R 24/30; H01R 31/06; H01R 13/7172

(57) ABSTRACT

The invention relates to novel ornamental and utilitarian features of a backup power control system comprising a remote sensing unit in communication with a backup power control unit. The remote sensing unit is configured to detect the status of a power grid and transmit such status to the backup power control unit.

### CLAIM TO PRIORITY

This application is a continuation of U.S. application Ser. No. 16/182,145, filed on 6 Nov. 2018, which claims priority to U.S. provisional application 62/648,977, filed on 28 Mar. 2018, and provisional application 62/673,224, filed on 7 Nov. 2017, which are incorporated by this reference for all that they disclose for all purposes.

### TECHNICAL FIELD

The invention relates to novel ornamental and utilitarian features of a backup power control system comprising a remote sensing unit in communication with a backup power control unit. The remote sensing unit is configured to detect the status of a power grid and transmit such status to the backup power control unit.

### BACKGROUND OF THE INVENTION

As is well known, an electric utility is a company in the electric power industry that engages in electricity generation and distribution for sale in a regulated market such as the residential market. An electric power system is a group of generation, transmission, distribution, communication, and other facilities that are physically connected and collectively referred to as the “utility power grid.” All electrical equipment, including the power grid, will fail given enough time even under normal use. Unfortunately, such failures often happen when people generally need power the most.

Permanently installed home backup generators is a prior art method used to address power grid failures. Such generators can run on diesel, natural gas and liquid propane (LP), and sit outside the home and look similar to a central air conditioning unit. The typical home backup generator delivers power directly to the home's electrical system, using the same electrical connection points as the power grid, backing up the entire home or just the most essential items. While such systems are available, few homes in the United States have such backup systems for at least two reasons: (1) the US power grid is very dependable substantially reducing the need for such a system (except recently in California); and (2) generator backups are expensive ($5,000 to $10,000 installed). Couple (1) and (2) together and most people do not see a need to invest the money in such a system. Yet, one day the power grid will fail, and at such time people will wish they had such a backup system.

While most homes do not have a $10,000 backup system many do have, or can purchase upon need, a portable 11,000-Watt generator for between $700-$1000 dollars or a 4,000-Watt generator for $300 to $600 that can run 10 hours on a full tank of fuel at 50% load. Such a cost is doable for most people in the US when the need arises. Further, typical power requirements for 120v electric equipment found in the home include (watts): microwaves 1300-start/1300-run, refrigerators 1500-start/200-run, TVs 200-start/200-run, coffee makers 600-start/600-run. Power requirements for 240 v electric equipment include electric ranges 2100-start/2100-run and water heaters 4500-start/4500-run. Thus, in an emergency, one can purchase a $300 generator and easily power a refrigerator, TV, coffee maker, several LED lights and microwave if one can connect a portable generator to the home electrical grid. Purchase an 11,000-watt generator, and one can even power a water heater and take hot showers.

The typical residential power system comprises a “home power gird” (wiring in a home) connected to the utility company power grid. Notably, for a home power grid, many power outlets are connected to the same electrical circuit. Each circuit is separated from the utility company power grid by a common breaker (i.e. the well-known breakers in your home breaker box). Thus, if the utility power fails, one can turn off the breaker for electrical circuit X to isolate electrical circuit X from the utility grid. If electrical circuit X has five outlets (for example) one can then connect an external power source (such as a power generator) to one of the free outlets of the electrical circuit X and “back feed” power into such free outlet and power the devices connected to the remaining four outlets. For example, suppose a kitchen has an electrical circuit that has five outlets. One outlet is connected to a refrigerator, one is connected to a microwave and one is connected to a coffee maker with two free outlets. One can back-feed power into one of the free outlets to supply power to the microwave, coffee maker and refrigerator.

Safety concerns arise, however, when back-feeding power into an electrical circuit as described above (e.g. supplying a power outlet with power instead of receiving power from such an outlet). As is well known, a power generator/source such as a portable generator provides power through female outputs. Further, the home outlet that is to be associated with the power generator output is a female connection. Thus, a male to male connection configuration (of some type) is required to transfer power from the external power source to a home power outlet. Such a configuration can result in one end of a male to male connection having exposed conductors with active power. Great care is taken in all countries by the electrical industries to ensure such never happens for obvious safety reasons.

The safety aspects of back-feeding power into a home power outlet are not limited to damaging humans via handling a ‘live’ plug but also damaging hardware such as wiring, breakers, and equipment connected to the wiring from overvoltage issues which would likely occur when the utility power grid power is restored and connected to a circuit being back-feed power as described above.

Therefore, there is a need to provide a means and method that allows a common person, who is not an electrician, without the help of an electrician, to safely connect the female power output of a temporary power source to the female outlet of a home power grid during a power outage until the utility company restores power to the home. The disclosed technology addresses such issues.

### SUMMARY OF THE INVENTION

Some of the objects and advantages of the invention will now be set forth in the following description, while other objects and advantages of the invention may be obvious from the description or may be learned through practice of the invention.

Broadly speaking, a principle object of the present invention is to provide a remote sensing unit configure to detect the status of a power grid associated back-feeding control system to a backup power control unit configured for electrically associating an output interface defined by a power generator with the same type output interface defined by an electrical circuit.

Yet another object of the invention is to provide a remote sensing unit comprising an interface configured for being electrically associated with a power grid that can detect the difference between a main power grid failure and the remote sensing unit being disconnected from a power grid.

Additional objects and advantages of the present invention are set forth in the detailed description herein or will be apparent to those skilled in the art upon reviewing the detailed description. It should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, the substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description).

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a perspective view an exemplary electrical wiring system for a typical residential home;

FIG. 2 is a perspective view of a typical residential kitchen being powered by a portable power generator;

FIG. 3 is a front elevational view of an exemplarily backup power control unit (BPCU) comprising BPCU outlets;

FIG. 4 is a side perspective view of the BPCU of FIG. 3;

FIG. 5 is a front elevational view of a BPCU comprising a display;

FIG. 6 is a side perspective of a Remote Sensing Unit (RSU) comprising LED indicators and RSU outlets;

FIG. 7 is a front elevational view of a RSU comprising a display and RSU outlets;

FIG. 8 is an alternative embodiment of an RSU with a wired communication connection to a BPCU;

FIG. 9 is a block diagram schematic representation for one exemplary circuitry for a BPCU;

FIG. 10 is a block diagram schematic representation for one exemplary circuitry for an RSU; and

FIG. 11 is one method of back feeding power into the output of an electrical circuit.

Repeat use of reference characters throughout the present specification and appended drawings is intended to represent the same or analogous features or elements of the present technology.

### DISCLOSURE OF THE INVENTION

### Detailed Description

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only and is not intended as limiting the broader aspects of the present invention.

### Construction Aids

For the purposes of this document two or more items are “mechanically associated” by bringing them together or into relationship with each other in any number of ways including a direct or indirect physical “releasable connections” (snaps, screws, Velcro®, bolts, clamps, etc.—generally connections designed to be easily, perhaps frequently, released and reconnected), “hard-connections” (welds, rivets, macular bonds, generally connections that one does not anticipate disconnecting very often if at all—a connection that is “broken” to separate), and/or “moveable connections” (rotating, pivoting, oscillating, etc.).

Similarly, two or more items are “electrically associated” by bringing them together or into a relationship with each other in any number of ways, including (a) a direct/indirect or inductive communication connection, and (b) a direct/indirect or inductive power connection. Additionally, while the drawings may illustrate various electronic components of a system connected by a single line, it will be appreciated that such lines may represent one or more signal paths, power connections, electrical connections and/or cables as required by the embodiment of interest.

For the purposes of this document, unless otherwise stated, the phrase “at least one of A, B, and C” means there is at least one of A, or at least one of B, or at least one of C or any combination thereof (not one of A, and one of B, and one of C). As used herein, the terms “first,” “second,” and “third” may be used interchangeably to distinguish one component from another and are not intended to signify the location or importance of the individual components unless specifically stated otherwise. As used in the claims, the definite article “said” identifies required elements that define the scope of embodiments of the claimed invention, whereas the definite article “the” merely identifies environmental elements that provide context for embodiments of the claimed invention that are not intended to be a limitation of any claim.

This document includes headers that are used for place markers only. Such headers are not meant to affect the construction of this document, do not in any way relate to the meaning of this document nor should such headers be used for such purposes.

### Description

While the particulars of the present invention and associated technology may be adapted for use for any type of electrical system, the examples discussed herein are primarily in the context of connecting a portable generator output with a power outlet of a residential home.

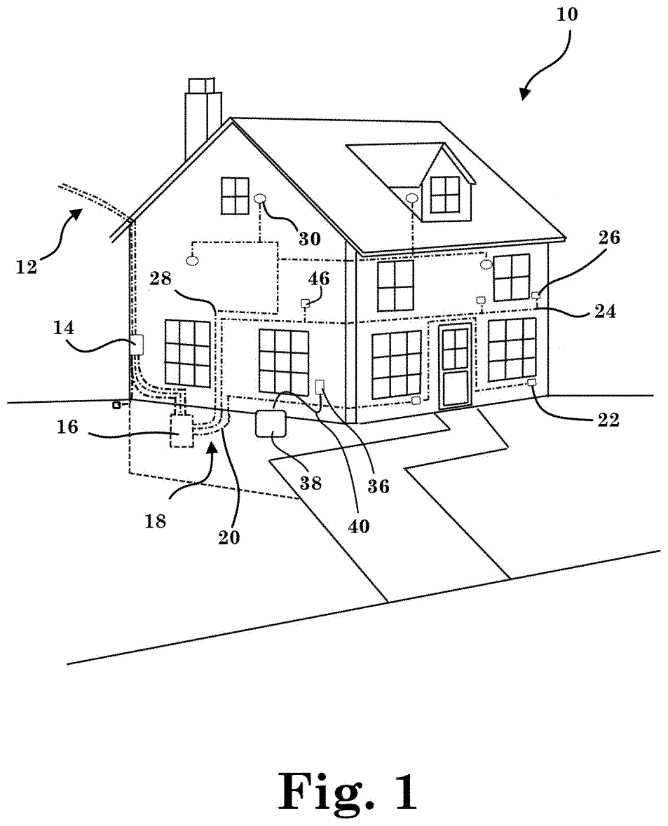

Referring now to FIG. 1, the configuration of a typical electrical system for a residential home 10 is considered. As is well known in the art, the wiring system of a residential home 10 is connected to a “single-phase” (relative to the power grid—which is split into two 120 volt phases via a transform at the utility pole) power source 12 capable of providing 120 v or 240 volts and is referred to herein as the “main power” or “main power grid.” The main power grid conductors 12 connect to a power meter 14, which meters power consumption. The metered power conductors (along with a neutral and ground conductor) are then connected to a breaker box/fuse box 16 (located in a basement in FIG. 1) and distributed through breakers/fuses to a plurality of electrical circuits 18 distributed throughout the home 10. For the example used in this description, there are three electrical circuits. One electrical circuit 20 feeds power to a plurality of female power outputs 22 on the ground floor. One electrical circuit 24 feeds power to a plurality of female power outputs 26 on the second floor. One electrical circuit 28 feeds power to a plurality of female lighting fixtures 30. It should be appreciated that electrical circuit 20 feeds three outputs referred to collectively as outputs 22 and individually as output 22a, output 22b, and output 22c. If the power fails for such electrical circuit 20, all three such outputs 22a, 22b, 22c will lose power. Conversely, if any of the outputs 22 of such electrical circuit 20 has power, they all have power.

A common residential circuit is protected by a 15-amp or 20-amp breaker at the breaker box 16, and thus, such a circuit can supply 15/20 amps of current (15/20 means 15-amps or 20-amps) before the breaker trips thereby isolating that circuit from the mains power 12 and stopping current flow between the mains power system and the home circuit. It should be appreciated, as described above, that one 15/20-amp circuit is generally configured to supply power to a plurality of power outputs 22, which may feed power to a plurality of electric devices (such as lamps, TVs, Microwaves, etc.). For example, one 20-amp circuit feeding power to four power outputs can easily supply power to a microwave, a refrigerator, at TV, and a coffee maker.

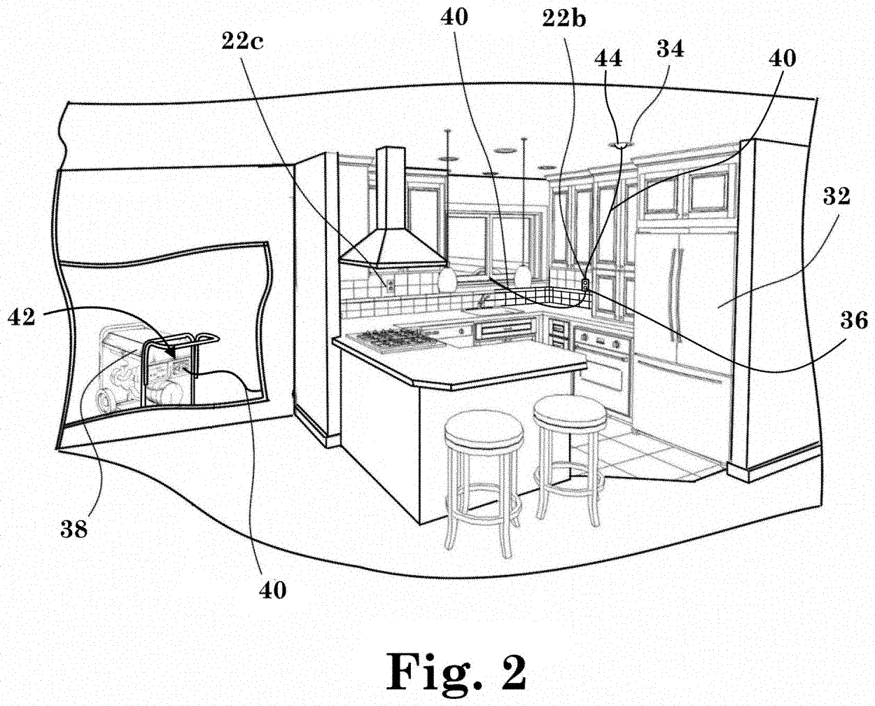

Referring now more particularly to FIG. 1 and FIG. 2, a typical residential home 10 wiring system (FIG. 1) and kitchen area (FIG. 2) are presented comprising a refrigerator 32 and a lighting system 34 being powered by a backup power source 38. The refrigerator 32 is electrically associated with a power output 22a (not shown) associated with a first electrical circuit 20. The first electrical circuit 20 is also electrically associated with power outputs 22b and 22c. The lighting system 34 is electrically associated with power output 30 for a second electrical circuit 28. For this example, power has failed and a Backup Power Control Unit (BPCU) 36 has been plugged into output 22b. The BPCU 36 is connected to an external power source 38 via BPCU power cable 40 and is back-feeding power into output 22b, which is also supplying power to output 22a (and thus providing power to the refrigerator 32) as well as power output 22c (which is not being used).

For this example, a power cable 42 is connecting the BPCU 36 to a Backup Power Lighting Adapter (BPLA) 44 connected to a light fixture output 30 and is supplying power to the associated lighting system 34. For one alternative embodiment, the BPLA 44 may be replaced by a Remote Sensing Unit (RSU) 46 that could be electrically associated with the BPCU 36 via an RSU cable 48. Such configurations will be defined in detail later.

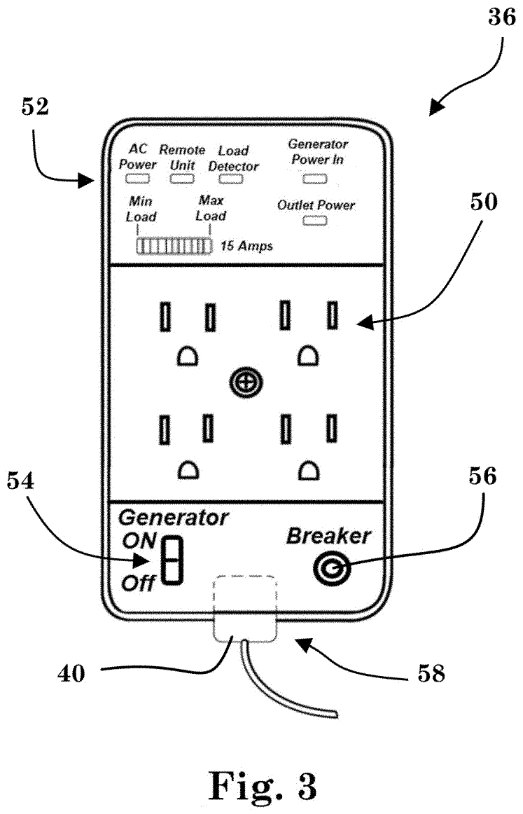

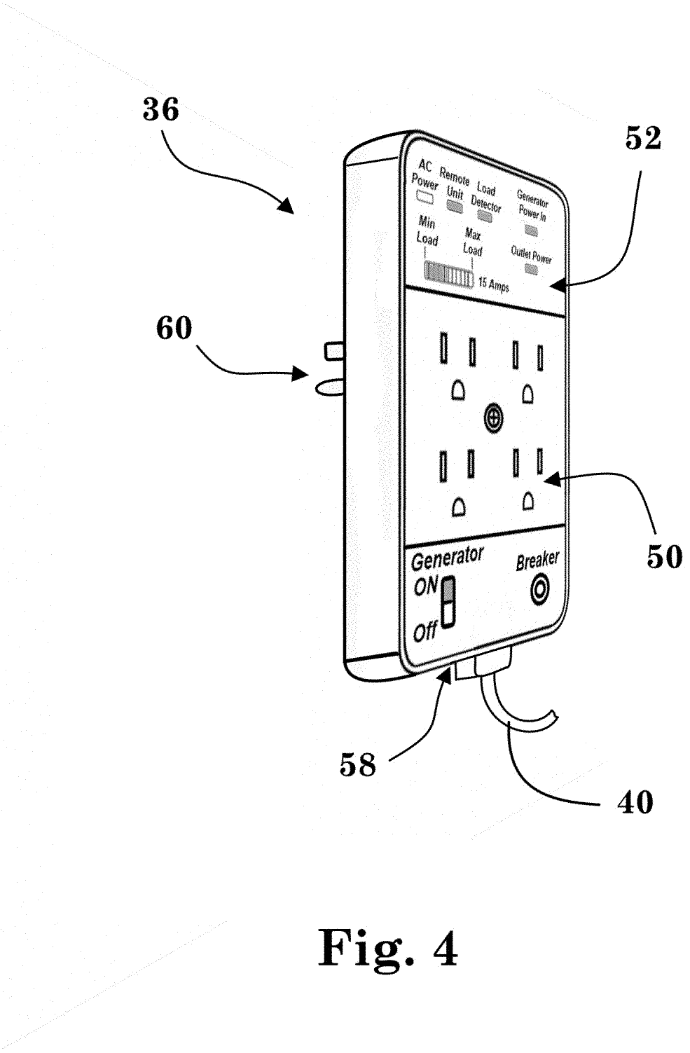

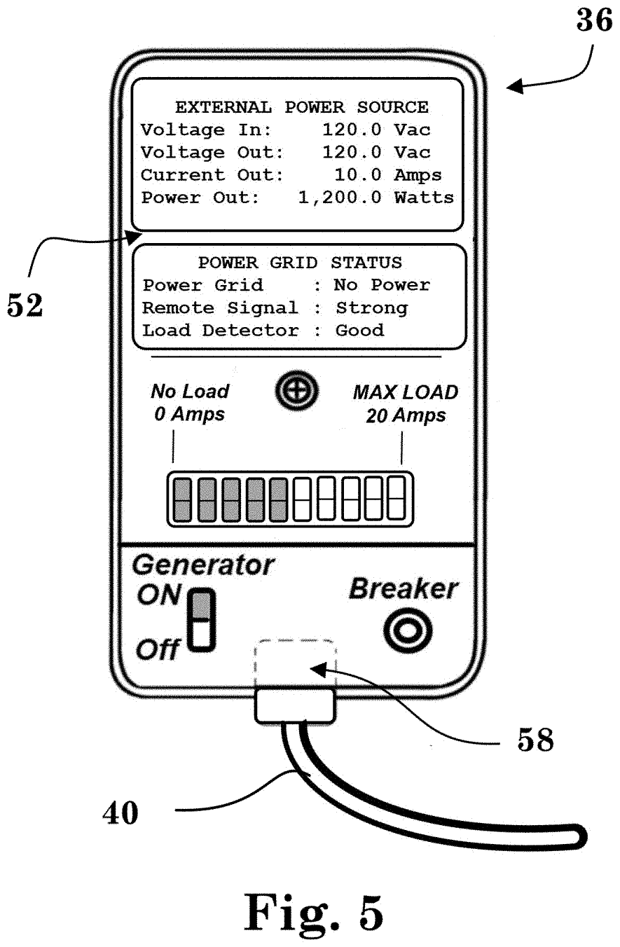

Attention is now directed more particularly to the BPCU 36 as depicted in FIG. 3, FIG. 4 and FIG. 5. Such figures present various views for embodiments of a BPCU 36. The BPCU 36 determines when to back-feed power from the backup power source 38 into a home output 22. The BPCU 36 also defines optional BPCU outlets 50 that are powered by the backup power source 38. As described below, directing backup power to the BPCU outlets 50 is not as risky as back-feeding power into a home outlet 22. Thus, ideally, as described later, the BPCU outlets 50 are directly connected to the backup power source 38 and provide backup power whenever there is backup power available.

The BPCU 36 further defines optional BPCU status indicators 52 that indicate system statuses including the main power grid 12, the connection to an RSU 46, home circuit breaker status (aka: “Load Detector”), backup generator power 38 status, output power status (i.e. is power being back-fed into the home outlets 22), and the current load on the system. For this embodiment, such status indicators are LEDs. One of ordinary skill in the art will appreciate that any number of status indicators may be provided without departing from the scope and spirit of the inventions.

A BPCU power switch 54 may be provided, for enabling/disabling the BPCU 36, and the BPCU 36 may be protected by a BPCU breaker 56. A BPCU power cable 40 is shown plugged into a BPCU input 58 configured for receiving a cable connected to a power generator output 42. For one embodiment, the BPCU power cable 40 defines a genderless connection (i.e. neither male nor female). As best seen in FIG. 4, the BPCU 36 may define a male interface 60 comprising a CUO-hot-conductor (“CUO” control unit output) and a CUO-reference-conductor. As will be described in detail below, the male interface 60 may be configured for being electrically associated with an electrical circuit female output 22 associated with a main power grid 12. Alternatively, the control unit may also define an output configured to be associated with power cable using a genderless connector. FIG. 5 presents a front elevational view of a BPCU 36 comprising an LCD to display BPCU status indicators 52.

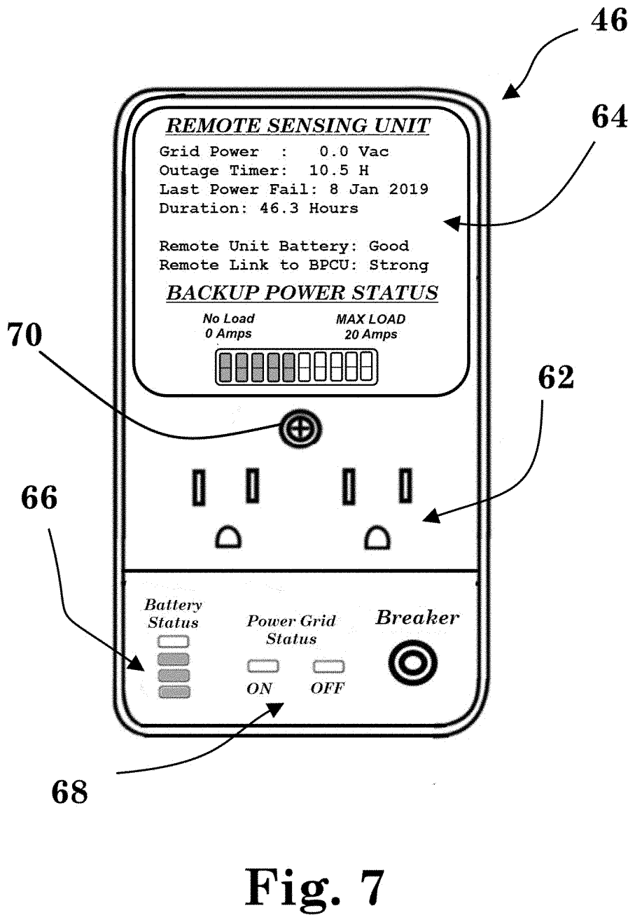

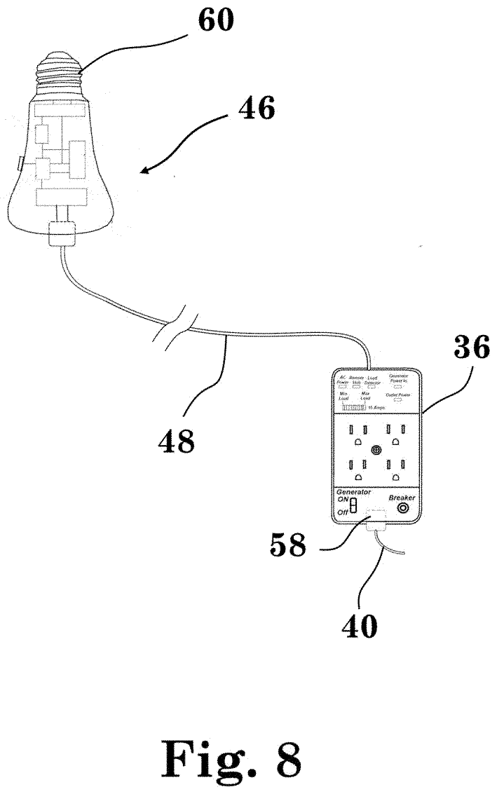

Attention is now directed to the Remote Sensing Unit (RSU) 46 depicted in FIG. 7 and FIG. 8. As explained previously, it would be dangerous to have the mains power 12 provided to a circuit that is being back-fed power. Thus, when back-feeding power into a home output 22 due to a main power grid 12 failure, one should disconnect the backup power source 38 from the outputs 22 before connecting main power 12. Such would not be a problem, normally, as the breaker 16 connecting a home output 22 to the main power grid should be OFF (thereby isolating such output from the main power grid) before back-feeding power into such output. That said, once the main power 12 is repaired, someone will eventually forget and turn a breaker 16 ON applying main power 12 to an output 22 being back-fed power. The RSU 46 monitors the main power 12 to determine the status of the main power 12 and transmits a status signal reflective of the main power 12 status to the BPCU 36.

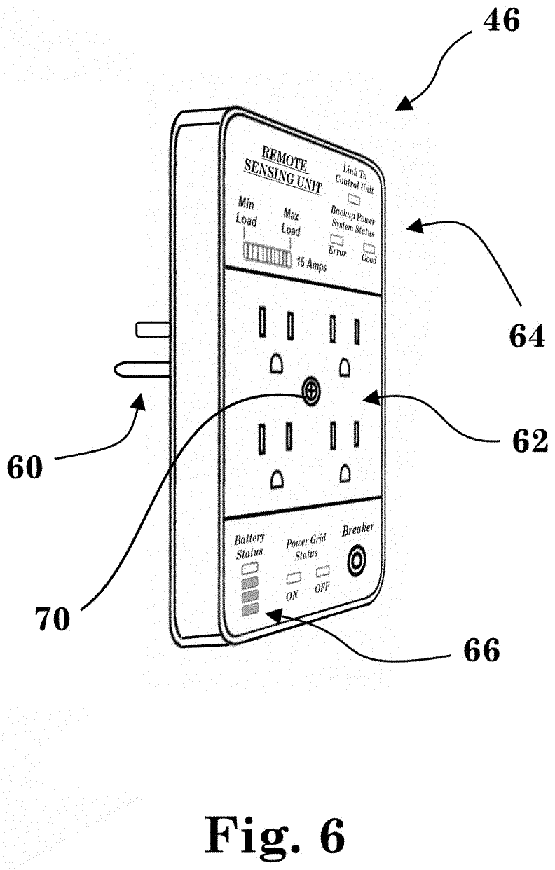

Referring now to FIG. 6 and FIG. 7, embodiments of a Remote Sensing Unit (RSU) 46 configured for being connected to an electrical circuit output 22 are presented. The RSU 46 is configured with an RSU male interface 60 (similar to the BPCU 36 male interface described above) configured to be electrically associated with a female output 22 of an electrical circuit where the female output 22 is electrically associated with the main power grid 12 as described above. The RSU 46 optionally provides RSU outlets 62 that are electrically associated with the male interface 60 so that when there is main power 12 at the male interface 60 such power is passed on to the RSU outlets 62. The RSU 46 may provide RSU status indicators 64, and for embodiments including a battery, there may be a battery status indicator 66 that indicates the charge status of the RSU battery or similar power storage device. The RSU 46 may additionally provide a power grid status indicator 68, visually indicating the status of the power grid 12. For the embodiment depicted in FIG. 6, the status indicators are LEDs or similar devices. For the embodiment depicted in FIG. 7, the status indicators 64 are presented using a display such as an LCD. FIG. 7 shows a mixture of LCD and LED indicators. The RSU 46 and BPCU 36 may be mechanically associated with a home output 22 using a fastener 70, such as screws, bolts, and/or clips.

It should be appreciated that the RSU 46 and the BPCU 36 should be associated with different electrical circuits 22, 26. For example, suppose the BPCU 36 is connected to a first electrical circuit 20 output 22 and the breaker 16 for the first electrical circuit 20 is tripped (turned off) thereby isolating the BPCU from the main power grid. The RSU 46 should be connected to a second electrical circuit 24 output 26 and the breaker for the second electrical circuit 24 should remained closed (turned on) thereby coupling the RSU 46 to the main power grid 12 (so that it can “see” the power grid 12 transformer).

The embodiments for a BPCU 36 and RSU 46 depicted in FIG. 3 through FIG. 7 communicate through wireless technology, although wired communications can be used in place of, or in addition to, wireless technology. The embodiment depicted in FIG. 8 shows a wired version of the system. The BPCU 36 comprises RSU communication circuitry in wired communication with an RSU 46 via an RSU sensor cable 72. For this configuration, the RSU 46 is configured with an RSU male interface 60 that can be screwed into a typical light socket. For this embodiment, the RSU 46 does not supply power to the light fixtures 30 but may supply power to the RSU 46 to power the RSU 46 so that so that the RSU 46 can sense the power grid 12 status via the associated electrical circuit 28.

For one alternative embodiment, a Backup Power Light Adapter (BPLA) 44 accessory, similar to the RSU in FIG. 8, may be associated with a light fixture output 30. The BPLA 44 is a simple device that simply receives power from the BPCU 36 via a BPLA power cable electrically associated with the control unit output 60. Embodiments of a BPLA power cable include genderless connectors. The BPLA 44 may be screwed into a typical light fixture 30 of a lighting electrical circuit 28 and supply power to all the lights fixtures 30 associated with the lighting electrical circuit 28 as described previously.

### Backup Power Control Unit

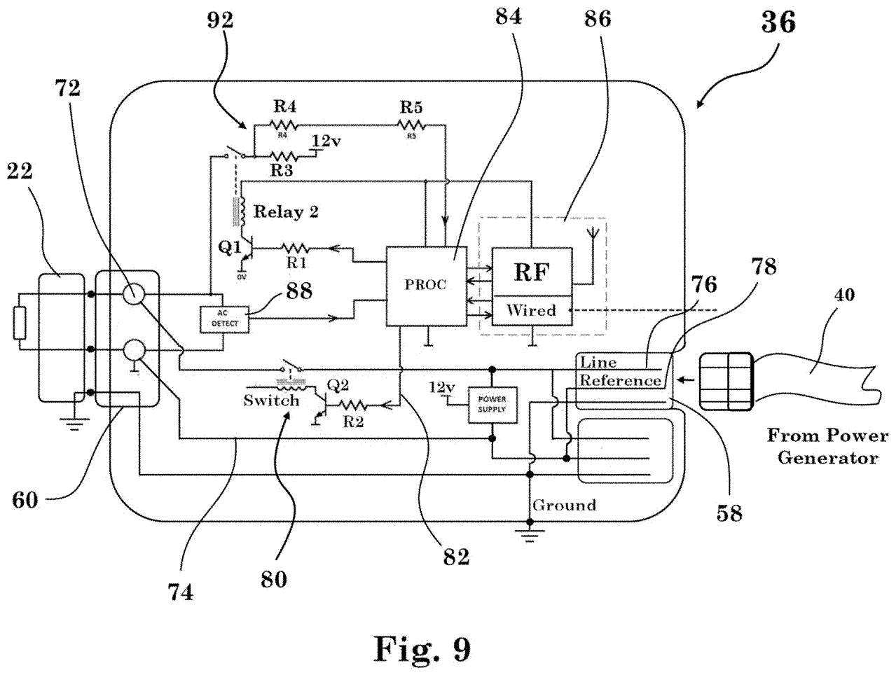

Attention is now directed more particularly to FIG. 9, which presents a block and schematic representation of a BPCU 36 for coupling an output 42 of a power generator 38 to an output 22 of an electrical circuit 20. For this embodiment, the BPCU 36 comprises a control unit output 60 comprising a CUO-hot-conductor 72 (“CUO”—Control Unit Output) and a CUO-reference-conductor 74. Examples of a “hot-conductor” include the line conductor suitable for connecting to a power grid 12 and include standard electrical conductors. Similarly, examples of a “reference-conductor” include standard electrical conductor configured to connect to a “neutral” or a “line” conductor of a power grid 12 (i.e. a reference point). The control unit output 60 is configured for being electrically associated with an electrical circuit 20 output 22 associated with a main power grid 12. For such configuration the CUO-hot-conductor 72 is configured for being connected to the line conductor of the main power grid 12 and the CUO-reference-conductor is configured for being connected to a line or a neutral (deepening on the voltage desired) of the main power grid 12.

As depicted in FIG. 3 through FIG. 5, the BPCU 36 defines a housing similar to a common 15-Amp 3-Wire Grounding Duplex to Six Adapter configured to be directly coupled to a duplex power outlet. Such configuration comprises standard straight blade connectors such as the ones depicted in FIG. 4 and FIG. 6. In the alternative, the BPCU 36 output 60 may be coupled to an electrical circuit using a cable. Ideally, for such a configuration, the BPCU 36 would define a genderless output configured for receiving a “safe connector” associated with a cable. Safe connectors are “genderless” (such as the ones sold by Anderson Power Products—more commonly used in solar power systems). That said, the BPCU 36 may define any suitable housing and coupling technology without departing from the scope and spirit of the invention.

The BPCU 36 further comprises a control unit input 58 comprising a CUI-hot-conductor and a CUI-reference-conductor (CUI—Control Unit Input) configured for being connected to a power generator 38 output 42. The power generator 38 output 42 defines a PGO-hot-conductor and a PGO-reference-conductor. Such means the CUI-hot-conductor is configured for being connected to the PGO-hot-conductor and the CUI-reference-conductor is configured for being connected to the PG-reference-conductor. Such a connection may be established by standard power cables or special power cables with “safe connectors” (genderless connection) as described above.

The BPCU 36 further comprises a switch 80 connected to the CUO-hot-conductor 72 and the CUI-hot-conductor 76. The switch 80 is configured to selectively connect or isolate the CUO-hot-conductor and the CUI-hot-conductor in response to a command signal 82. For the embodiment depicted in FIG. 9, the switch 80 comprises a relay driven by a transistor Q2 turned on or off by the command signal 82. Any suitable switching technology may be used including solid-state relays and electromagnetic relays.

The BPCU 36 comprises a first sensor configured to sense a first electrical parameter of the control unit output 60 and generate a first parameter signal reflective of the first electrical parameter. The BPCU 36 further comprises a processor 84 electrically associated with the switch 80 and the first sensor. The processor 84 is configured to generate the command signal 82 based on predefined switching criteria related to sensor data related to one or more electrical parameters associated with the CUO-output 60. Processor 84 performs control tasks as well as communications for embodiment comprising communication circuitry 86. The processor 64 may be further configured to use the communication circuitry 86 to communicate with remote devices such as an RSU 46 and/or a Smartphone or similar device.

Fundamentally, the processor 84 generates a command signal 82 that causes/directs the switch 80 to connect or remove a power generator 38 power path to a selected electrical circuit 20 under certain conditions defined by sensor data (and/or data received from an RSU 46. Thus, as noted above, the BPCU 36 further comprises at least one sensor associated with the processor 84 and the control unit output 60 configured to sense electrical parameters for the control unit output 60 and generate a control unit output parameter signal reflective of a measured electrical parameter. The processor 84 generates the command signal 82 based at least in part on the control unit output electrical parameter signal(s).

It will be appreciated that when trying to back-feed power into a home electrical circuit (for example) the breaker 16 for such electric circuit should be open/tripped, thereby isolating your home electrical circuit from the power grid. Otherwise, when one tries to back-feed power into the electrical outlet the power grid will suck up the power and try to distribute the power to your neighbors. Thus, initially, it should be appreciated that, before back feeding power into an electrical circuit 20, the breaker 16 for an electrical circuit 20 is turned off and the BPCU 36 output is then connected to an output 22 associated with the electrical circuit 20. The BPCU 36 input is then connected to the output 42 associated with the backup power source 38 and the backup power source is started. When the backup power source 38 starts supplying power to the BPCU 36, it powers up its internal electronics but does not pass backup power to the output 22 until predefined tests are passed. Alternatively, an internal power source such as a battery may be used and the BPCU 36 may be powered on when there is not backup power 38.

For one such test, the BPCU 36 may comprise a first sensor defining an AC Detector 88 configured to detect a potential difference between the CUO-hot-conductor and the CUO-reference-conductor or similar reference point. Once the BPCU 36 is powered on, the BPCU checks the AC Detector 88 sensor to determine if the control unit output 60 has a voltage. If there is zero volts (or some value reflective of zero volts) such would be a “pass” for the voltage parameter test. If the AC Detector 88 detects a voltage materially different from zero volts, something is wrong and such would be a “fail.”

The absence of a voltage at the control unit output 60 may be the result of the BPCU 36 not being associated with an output 22 (which is not a proper configuration). Thus, a second check should be performed to verify the BPCU 36 is connected to an output 22. Further, even if the BPCU 36 is connected to an output 22 as required, a user may forget to turn off the associated breaker 16. An impedance test for the BPCU 36 output 60 can be used to detect that (1) the BPCU 36 is connected to an output 22 and (2) the status of the breaker associated with the output 22.

For one configuration, the BPCU 36 may further comprise a second sensor defining an impedance detector 92 configured to measure/detect an impedance value for the control unit output 60. Thus, the processor 84 may be connected to a sensor configured to measure an impedance reflective of the impedance along the CUO-hot-conductor and some reference point associated with the control unit output 60. For this test, the processor 88 generates a signal to turn on Q1 that closes Relay 2, thereby connecting the R3, R4, R5 resistor network associated with a DC voltage to the control unit output 60 to measure an associated impedance. For such a configuration, one example of a control unit output parameter signal reflective of an electrical parameter may be a resistance value. Ideally, the second test would be performed after the first test (voltage test) for configurations having the voltage testing capability. The processor 84 may be configured to look for a resistance (impedance) value between a lower limit and upper limit where such limits represent different conditions. For example, if the measured impedance is below the lower limit such may indicate that the BPCU 36 is indeed connected to an electrical circuit output, but the associated breaker 16 is closed (i.e. the power grid 12 transformer is in the circuit). Such would be considered a fail. If the measured impedance is above an upper limit, such may be an indication of an open circuit, implying that the BPCU 36 is not connected to an electrical circuit. Such would be considered a fail. If, however, the measured impedance is between the lower limit and the upper limit, such may be an indication that the BPCU 36 is connected to an electrical circuit 20 and the associated breaker 16 is tripped/off isolating the selected electrical circuit 20 from the main power grid. Such would be considered a pass.

Ideally, both upper and lower impedance limits are tested to pass the impedance test although only one, or none, may be required. If the impedance test yields an impedance below the lower limit, the processor may issue a “Breaker Failure” error indicating the breaker 16 is closed. If the impedance test gives a value above the upper limit, the processor 84 may issue a “Connection Failure” failure indicating the BPCU 36 is not connected to an output 22.

For a “fail” condition, the processor 84 generates a command signal 82 that instructs/causes switch 80 to isolate CUI-Hot-Conductor 76 from CUO-Hot-Conductor 72. For the embodiment in FIG. 9, such a command signal 82 is the absence of a voltage needed to turn on Q2. Restated, not generating a voltage needed to turn on Q2 is the command signal 82 for this example. If the processor 84 determines all sensor tests have passed, the processor 84 generates a command signal 82 that instructs/causes switch 80 to couple the CUI-Hot-Conductor 76 to the CUO-Hot-Conductor 72 or processor 84 performs other checks related to other switching criteria such as checking a RSU status signal described below.

As noted previously, the BPCU 36 may comprise communication circuitry 86 configured to receive a main power grid status signal generated by a remote sensing unit (RSU) 46 connected to a second electrical circuit female output associated with the main power grid. For such embodiment, the processor 84 may be further configured to generate the command signal 82 based at least in part on the main power grid status signal. Such will be described in detail below.

### Remote Sensing Unit

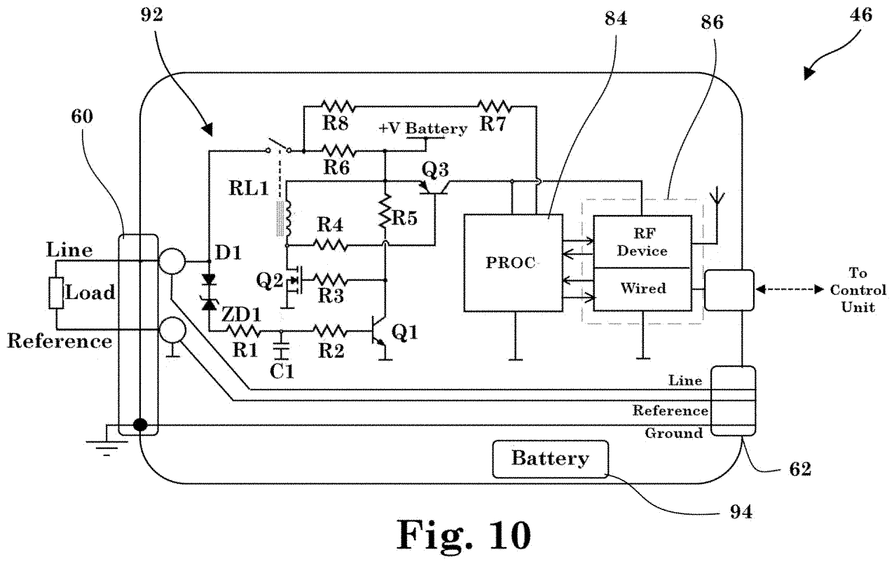

Attention is now directed more particularly to FIG. 10, which presents a block and schematic representation of a Remote Sensing Unit (RSU) 46 for a system, such as BPCU 36, configured for back feeding power from power generator 38 into an output 22 of an electrical circuit 20 for an electrical system comprising a plurality of electrical circuits. The RSU 46 comprises an RSU interface 60 configured for being electrically associated with a first electrical circuit 20 electrically associated with a main power grid 12. As noted previously and as depicted in FIG. 6, the RSU interface 60 may define a male interface 60 similar to the BPCU 36 male interface depicted in FIG. 4. Alternatively, the RSU interface 60 may define a male interface 60 that can be screwed into a typical light fixture (aka light socket), as depicted in FIG. 8. It should be appreciated that the RSU 46 does not supply power to either the output 22 nor the light fixtures 30 but is configured to sense the power grid 12 status through such electrical circuit.

The RSU 46 may further comprises a processor 84 electrically associated with communication circuitry 86 comprising wireless and or wired technology. As noted previously, the BPCU 36 and RSU 46 depicted in FIG. 3 through FIG. 7 communicate through wireless technology. The embodiment depicted in FIG. 8 shows a wired version of the system where communications occur over an RSU sensor cable 48 (which may also supply power to the RSU as described below).

The RSU 46 further comprises an RSU interface sensor 92 electrically associated with said processor 84 and said RSU interface 60 and configured to detect/measure an electrical parameter associated with the interface 60. If the RSU 46 is properly connected to an electrical circuit as described above, such electrical parameter may also be reflective of an electrical parameter of the first electrical circuit. When connected to an electrical circuit 22, the interface status signal, which is reflective of an electrical parameter associated with the interface 60 should also be reflective of the status of the main power grid 12. The processor 84 is configured to generate and transmit a power grid status signal reflective of at least one of a properly connected RSU 46 and or a main power grid failure. For one embodiment, the RSU 46 remains dormant until there is not voltage (or a voltage below a predefined limit) measured at the interface 60 indicating is a power grid 12 failure. Thus, when there is a voltage at interface 60, the power grid status signal may be the absence of a signal.

There are two basic power grid conditions: (1) a power grid failure and (2) a power grid good condition. For a power grid failure condition, there will be no voltage (or a low voltage) at the RSU 46 interface. For a power grid good condition, there will be a voltage at the RSU 46 interface.

For a power grid failure condition, for the embodiment depicted in FIG. 10, the RSU interface sensor 92 determines both: (1) is there a main power grid failure (i.e. a first test—what is the interface voltage); and (2) is the RSU interface 60 properly connected to an output 26 electrically associated with an electrical circuit 24 associated with a main power grid 12 (i.e. a second test, what is the interface impedance). Restated, test 2 simply verifies if the no voltage condition at interface 60 is due to a power grid failure or the RSU 46 simply not being plugged into an output associated with the power grid.

For power grid failure condition, test 1 (voltage test), transistor Q1 will turn OFF (as it is powered by the interface voltage and there is not interface voltage). When Q1 turns off such allows a voltage at the base of Q2 which turns ON via the RSU power source 94. The RSU power source 94 may be a battery as depicted in FIG. 10 or such power source may be supplied by the BPCU 36 via an RSU sensor cable 48. With Q2 ON, RL1 engages to power up the processor 84 and the communication circuitry 86 via Q3. The processor can then generate a power grid status signal reflective of the electrical parameter for the interface 60 which should allow be reflective of a power grid failure. Such power grid status signal may be transmitted to a remote device such as a BPCU 36.

For power grid failure condition, test 2 (impedance test—optional test), the processor 84 is powered up and can perform test 2 (impedance test). Under such conditions current will flow to the interface 60 and through the selected output 26 electrically associated with an electrical circuit 24 which will result in an interface 60 terminal voltage proportional to the load associated with the RSU interface 60. The impedance value reflective of the load can then be measured by the processor 84 ADC input via the sense resistors R8 and R7. The processor 84 may then add the impedance information to the generated power grid status signal which may now be reflective of both (1) a properly connected RSU 46 and/or (2) a main power grid failure. For the simplest configuration, such a status signal may be a simple OK signal with a more complex status signal comprising, for example, the interface 60 load resistance measurement.

For the condition where there is a power grid has not failed the interface 60 voltage will be above a predefined level (probably 120 volts or 220 volts). Thus, here, the RSU interface 60 is associated with an output 26 electrically associated with an electrical circuit 24 that is supplying power (i.e. no main power grid 12 failure). The voltage at the interface 60 input is rectified by diode D1 and capacitor C1 to provide the DC current required to turn “ON” transistor Q1. With Q1 ON the junction of R3 and R5 (i.e. base of Q2) is pulled low turning OFF Q2. With Q2 OFF the relay RL1 is not engaged and transistor Q3 is turned OFF. When Q3 is turned off, the processor 84 and communication circuitry 86 are turned OFF (i.e. dormant). Thus, for this configuration and interface 60 condition, the RSU status signal can be considered generating no signal. Restated, the processor 84 generates an interface status signal by generating no signal at all. Such a configuration is designed to minimize power consumption from a depletable RSU power source 94 such as a battery.

For one alternative embodiment, the RSU power source 94 may comprise a battery configured to power the RSU 46 for extended periods of time. For such embodiment, the processor 84 may be configured to generate and transmit a power grid status signal reflective of the connection status of the RSU 46 and the status of the main power grid 12 even when the main power grid 12 has not fail and is providing a voltage at the interface 60.

The embodiments above present a custom RSU interface sensor 92 design. It should be appreciated that any suitable RSU interface sensor 92 technology may be used without departing from the scope and spirit of the invention.

As best seen in FIG. 6 and FIG. 7, for one embodiment, the RSU 46 further comprising at least one remote sensing unit female outlet 62 that is coupled to the RSU interface 60. Such allows AC power supplied by the main power grid 12 to be passed through to the female outlets 62. Such a configuration is particularly useful for systems where the RSU 46 is designed to be connected to an outlet 22, 26, 30 all the time.

### Method

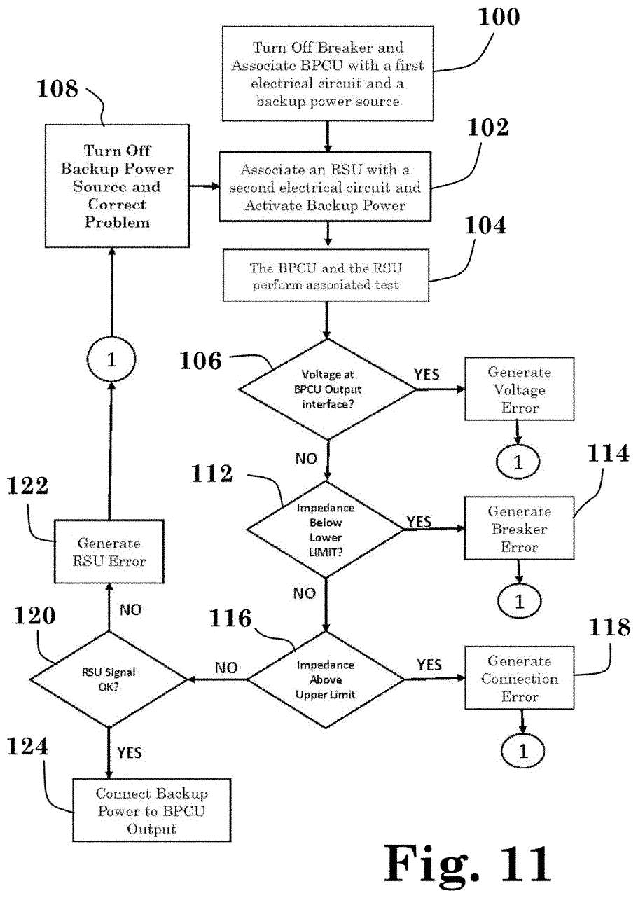

Referring now to FIG. 11, methods of back feeding power into the output 22 of an electrical circuit 20 associated with a power grid 12 through breakers 16 are considered. At step 100, an electrical circuit 20 for back feeding power is selected and the associated breaker 16 may be turned off and a BPCU 36 may be associated with the output 22 for such electrical circuit 20. At step 102, an RSU 46 may be associated with the output 26 of a second electrical circuit 24 and the backup power source 38 may be started. At step 104 the BPCU 36 and the RSU 46 may start performing their respective tests on their respective interfaces 60. At step 106, the BPCU 46 may check for a voltage at its interface 60. If there is a voltage present, the processor 84 may generate a voltage error and program control passes to step 108 where the backup power may be turned off and the source of the error corrected. If there is no voltage on the BPCU 46 interface 60, at step 112 the BPCU 46 may check the impedance of the interface 60 and if the impedance is below a lower limit program control may pass to step 114 where the processor 84 may generate a breaker 16 error (indicating the breaker is closed when it should be open). If at step 112 the impedance is above the lower limit, program control may pass to step 116 where the processor may check to see if the interface 60 impedance value is above a predefined upper limit. If yes, program control may pass to step 118 and the processor 84 may generate a connection error (indicating the BPCU is not connected to an output) and program control may then pass to step 108 as before. If at step 116 the impedance is below a predefined upper limit, program control may pass to step 120 where the processor 84 may check for an RSU 46 status signal. If the RSU status signal is not OK, program control may pass to step 122 where the processor 84 may generate an RSU failure. Program control may then pass to step 108 as before. If the RSU status is OK, program control may pass to step 124 and the backup power 38 may be connected to the output 22 and power may be made available for back feeding into output 22.

### Hardware

As depicted in the various figures the BPCU 36 and the RSU 46 comprise a processor 84. While the same reference number is used such processors need not be the same processor type. Processor 84 may be a microprocessor that supports standard operating systems and application software although other processing devices may be used such as ASICs (application specific integrated circuit) or ASSPs (application specific standard product) or PICs. The processing device may comprise onboard ROM, RAM, EPROM type memories for storing data and/or program code such as firmware. Processing device 82 may also comprise on-chip communication technology/circuitry (such as the ones manufacture by Microchip®) configured to transmit/receive a data signal to/from a remote electronic device. It should be appreciated that embodiments with communication circuitry 86 comprising a transceiver and/or only a transmitter fall within the scope of the invention. For one embodiment, the communication circuitry 86 consumes relatively low power and is configured to communicate with an external device that is expected to be within range of a low power transmitter signal. For example, for one embodiment the communication circuitry 86 may be configured to communicate with home communication system (e.g. WiFi, Security, etc.). Because such a system is expected to be within close communication range of the communication circuitry 86, the associated transmitter(s) can be relatively low powered thereby saving energy. That said, embodiments with more powerful transmitters may be used, including well-known technologies for wireless communications such as GPRS, GSM, GPRS, 5G, 4G, 3G, and EDGE enabled networks as well as WAP networks. Consequently, for some embodiments, the communication circuitry may define common cell phone communication technology.

Some embodiments may include both a low power transmitter and a high-power transmitter. For low power transceivers (a low power transmitter relative to the above described “high power” communication circuitry), such transceiver may operate in any number of unlicensed bands, although frequencies requiring a license may be used. Suitable technologies include Bluetooth and Zigbee (IEEE 802.15). Zigbee is a low data rate solution for multi-month to multi-year battery life applications. Zigbee operates on an unlicensed, international frequency band. Such technologies are known and understood by those skilled in the art, and a detailed explanation thereof is not necessary for purposes of describing the method and system according to the present invention. By way of example, the low power transmitter may provide communications with devices such as cell phones and may further be operable to transmit on one or more FM bands to provide communication through an FM radio.

One of ordinary skill in the art will appreciate that a BPCU 36 and an RSU 46 comprising such communication technology can be remotely monitored (e.g. temperature, power being supplied, voltage level, current being supplied, power generator fuel level, etc.) and controlled (e.g. turned on/off change switching element status, etc.).

As noted above, exemplary embodiments of a switch 80 include relays. A relay is an electrically operated switch. Many relays use an electromagnet to mechanically operate a switch, but other operating principles are also used, such as solid-state relays. The type of command signal used to control the switch 80 will depend on the switching technology used.

Generally speaking, the various electronic hardware comprises standard components known in the art although such hardware configuration and control routines are novel. One of ordinary skill in the art will recognize that the inherent flexibility of computer-based systems allows for a great variety of possible configurations, combinations, and divisions of tasks and functionality between and among components. For instance, methods discussed herein may be implemented using a single processor or multiple processors working in combination.

The various components discussed herein are not limited to any particular hardware architecture or configuration. Embodiments of the methods and systems set forth herein may be implemented by one or more general-purpose or customized computing devices adapted in any suitable manner to provide the desired functionality. The device(s) may be adapted to provide additional functionality complementary or unrelated to the present subject matter, as well. For instance, one or more computing devices may be adapted to provide desired functionality by accessing logic or software instructions rendered in a computer-readable form. When software is used, any suitable programming, scripting, or another type of language or combinations of languages may be used to implement the teachings contained herein. However, software need not be used exclusively, or at all. For example, some embodiments of the systems and methods set forth herein may also be implemented by hard-wired logic or other circuitry, including, but not limited to application-specific circuits. Of course, combinations of computer-executed software and hard-wired logic or other circuitry may be suitable, as well.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A remote sensing unit for a system configured for back feeding power from a power generator into an output of an electrical circuit for an electrical system comprising a plurality of electrical circuits, said remote sensing unit comprising:
a processor electrically associated with communication circuitry;
an interface configured for being electrically associated with a first electrical circuit electrically associated with a main power grid;
a sensor electrically associated with said interface and said processor wherein said sensor is configured to measure an electrical parameter associated with said interface and generate an interface status signal reflective of the electrical parameter; and
wherein said processor is configured to generate a power grid status signal when the interface status signal is reflective of a power grid failure.

2. A remote sensing unit as in claim 1, wherein the electrical parameter defines a voltage for said interface and wherein said processor does not transmit a power grid status signal when the interface status signal reflects a voltage above a predefined level.

3. A remote sensing unit as in claim 2, wherein the electrical parameter further defines an impedance for said interface and wherein the interface status signal is reflective of the measured impedance.

4. A remote sensing unit as in claim 3, wherein said interface status signal includes impedance information.

5. A remote sensing unit as in claim 2, wherein the processor is dormant when there is no voltage at said interface.

6. A remote sensing unit as in claim 1, further comprising a power storage device configured to power the remote sensing unit when the main power grid has failed.

7. A remote sensing unit as in claim 1, further comprising at least one remote sensing unit female outlet that is coupled to said remote sensing unit interface.

8. A remote sensing unit as in claim 7, further comprising a display electrically associated with said processor and wherein said display is configured for displaying main power grid status indicators.

9. A remote sensing unit as in claim 8, wherein the remote sensing device is in communication with a control unit connected to a backup power source back feeding power into a second electrical circuit associate with the main power grid and wherein said processor is configured to receive backup power status information from a the control unit and cause at least some of the backup power status information to be displayed on said display.

10. A remote sensing unit as in claim 1, wherein the communication circuit defines a wired circuit configured to receive a remote sensing unit cable and wherein the remote sensing unit cable further supplies power to the remote sensing unit.

11. A remote sensing unit for a system configured for coupling an output of a power generator to an output of an electrical circuit associated with a main power grid, said remote sensing unit comprising:
an interface configured for being electrically associated with an output electrically associated with a first electrical circuit electrically associated with a main power grid;
sensor means electrically associated with said interface for detecting a interface voltage parameter and an interface impedance parameter and generating an interface status signal; and
a processor means electrically associated with communication circuitry wherein said processor means is configured to generate and transmit a power grid status signal based at least in part on the interface status signal when the power grid is not providing a voltage at said interface..

12. A remote sensing unit as in claim 11, wherein the communication circuitry defines wireless technology an wherein said processor means is dormant when there is a voltage above a predefined level at said interface.

13. A remote sensing unit as in claim 11, wherein said processor generates and transmits a power grid status when there is a voltage at said interface.

14. A remote sensing unit as in claim 11, further comprising remote sensing unit female outlets coupled to said interface.

15. A remote sensing unit as in claim 14, wherein the communication circuitry defines a circuit configured to receive a remote sensing unit cable.

16. A remote sensing unit as in claim 15, wherein said remote sensing unit cable further supplies power to the remote sensing unit.

17. A remote sensing unit as in claim 11, further comprising a display electrically associated with said processor means and wherein said display is configured for displaying the status of the main power grid.

18. A remote sensing unit as in claim 17, wherein the processor means is configured to receive backup power status information from a remote device and cause at least some of the backup power status information to be displayed on said display.

19. A method of back feeding power from a power generator to the output of an electrical circuit, said method comprising the steps of:
turning off a breaker electrically associated with a first electrical circuit electrically associated with a power grid;
associating an CU-output defined by a backup power control unit with an output electrically associated with said first electrical circuit;
associating an CU-input defined by said backup power control unit with the output of a power generator;
associating a remote sensing unit with a second electrical circuit electrically associated with the power grid;
configuring said remote sensing unit to generate a power grid status signal;
configuring said backup power control unit to generate an CU-output status signal based on a voltage test reflective of a voltage defined at said CU-output; and
configuring said backup power control unit to selectively back feed power into said first electrical circuit based on said power grid status signal and said CU-output status signal.

20. A method of back feeding power from a power generator to the output of an electrical circuit as in claim 19, further comprising the step of configuring the backup power control unit to generate a second CU-output status signal based on a impedance test reflective of an impedance defined at said CU-output and configuring said backup power control unit to selectively back feed power into said first electrical circuit based on said power grid status signal, said CU-output status signal, and said second CU-output status signal.
